(19) United States
(12) Patent Application Publication
(10) Pub. No.: US 2006/0227246 A1
(43) Pub. Date: Oct. 12, 2006

(54) Apparatus and system for tv set with abundant patterns

(76) Inventor: Bi Ke, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/567,207

(22) PCT Filed: Jul. 28, 2004
(86) PCT No.: PCT/IB04/51313

§ 371 Date: Feb. 3, 2006

(30) Foreign Application Priority Data
Aug. 5, 2003 (CN) 03153015.X

(51) Int. Cl. H04N 5/50; H04N 9/76

(52) U.S. Cl. 348/569; 348/600

(57) ABSTRACT

This invention adopts a method for creating directly and instantly the character model information of the characters during the operation of the TV OSD software. When the characters need to be transferred and used during the operation of the TV OSD software, the character model information will be created by the TV OSD software without being read from the character storage stored in a specific area of the TV chip by the software, and then the created model information will be written into the RAM of the TV chip. When the TV OSD software is running, the TV OSD software can reduce the dependence on the character storage stored in a specific area of the TV chip, even need not to read the characters in the character storage stored in the specific area of the TV chip, so that this method solves the problem that the space of the ROM zone of the TV chip, which is used to store the character storage, is not enough relatively, and enhances greatly the flexibility of the development of the TV OSD software , thus this method benefits the TV manufacturers to develop the TV OSD software in a more abundant space.

### TECHENICAL FIELD

The present invention relates to a TV set, specifically to a TV set with patterns of TV on screen display (TV OSD).

### TECHNICAL BACKGROUND

TV OSD displays on a screen of TV set all of the contents except TV programs, which is an important user-oriented performance. The existing TV OSD software and its word bank are stored in different locations in ROM of TV chip after they have been developed. Every time the TV OSD software is running, the software reads word module information of characters from the word bank in ROM and writes the information to RAM of TV chip. These characters and the patterns composed of these characters are shown on a TV screen, which is referred to as TVOSD.

Nowadays, TV manufacturers are getting more and more demanding on TV OSD software and TV OSD patterns are getting more and more complicated, which require a larger and larger TV OSD word bank, but the storage space for TV OSD word bank provided by a TV chip is limited, so that the development of TV sets with more advanced TV OSD software is hampered.

Therefore there is a need for an improved method for displaying characters and patterns on TV screen, which will help the manufacturers to develop TV sets with more advanced TV OSD software.

### SUMMARY OF THE INVENTION

This invention provides a new method for displaying characters and patterns on TV screen. When the TV OSD software is running, it will rely less on the word bank stored in a specific area of TV chip, it can even work without reading the word module information of characters in the word bank stored in the specific area of TV chip. So the TV manufacturers can use more ample storage space to develop the TV OSD software.

This invention introduces a method for instantly generating the word module information of characters directly by a TV OSD software when it is running. When some characters are needed to be invoked during the TV OSD software running, the TV OSD software will directly and instantly generate the word module information rather than read them from the word bank stored in the specific area of TV chip, and then write the generated word module information into RAM of TV chip. Because of a certain relevancy among the word module lattices, the TV OSD software can generate a group of characters through predetermined algorithm.

According to the present, Compared with ROM area of TV chip for storing word bank, the ROM area of TV chip for storing the TV OSD software is much larger, so that the problem of ROM area of TV chip for storing word bank being limited is solved. And the running time is shortened because there is no need to read the word module information of characters from the word bank stored in the specific area of TV chip. Furthermore, the storage space in ROM of TV chip for storing the TV OSD software can be reduced if specific algorithm is used to generate the word module information of characters.

Through description of this invention incorporating accompanying drawings and claims, objects and achievements of the invention will be more apparent and comprehensive.

### BRIEF DESCRIPTION OF ACCOMPANYING DRAWINGS

The present invention will be described in detail with referent to accompanying drawings incorporating preferred embodiments, wherein FIG. 1A˜1C is a schematic diagram showing the running result of TV OSD software displayed on TV screen when the TV set is switched on according to an embodiment of the invention;

FIG. 1D˜1E is a schematic diagram showing a part of characters and word module information according to the embodiment of the invention;

FIG. 2 is a flow chart showing a running process of TV OSD software when the TV set is switched on according to the embodiment of the invention;

FIG. 3 is a flow chart showing a running process of TV OSD software when the TV set is switched off according to the embodiment of the invention.

FIG. 4 is a flow chart showing user's setting up TV OSD pattern properties for starting and shutdown of a TV set.

In all of these drawings, an identical reference number indicates the same or similar feature or function.

### DETAILED DESCRIPTION OF THE INVENTION

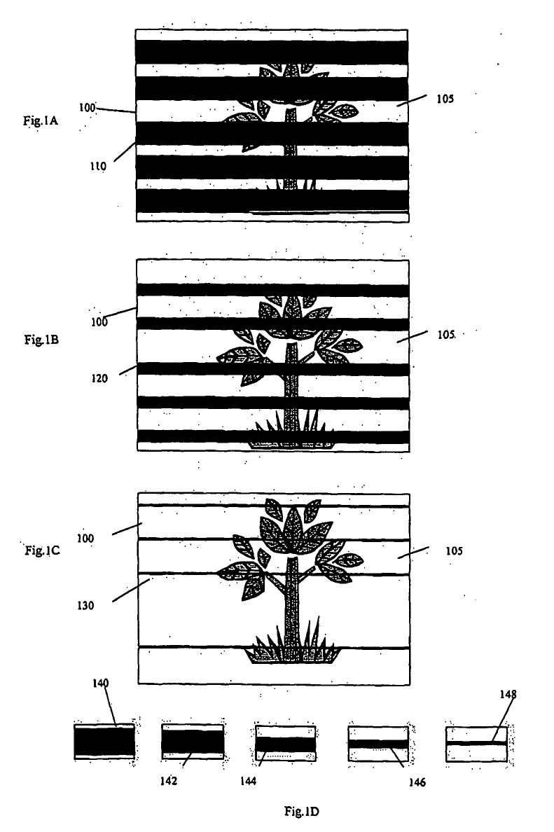

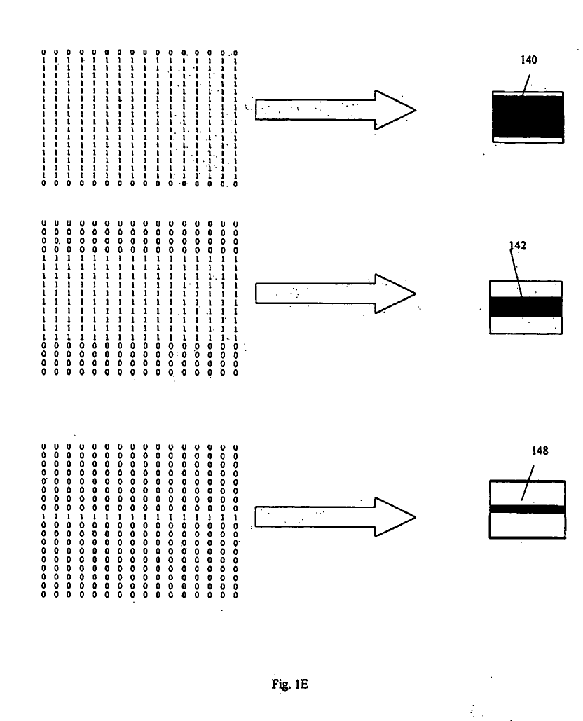

FIG. 1A˜1C is a diagram showing the running result of a TV OSD software displayed on TV screen when a TV set is switched on according to an embodiment of the invention. A tree image is TV content image signal 105, as shown on TV screen 100, and pattern 110 in FIG. 1A, pattern 120 in FIG. 1B and pattern 130 in FIG. 1C are TV OSD patterns. These patterns cover TV content image signal 05.

When the TV set is switched on, TV OSD software begins to run. The TV OSD patterns change from pattern 110 to pattern 120, then from pattern 120 to pattern 130, and this effect makes a smooth revealing of the TV content image, which looks just like opening a shutter. In this way, light stimulation of sudden appearance of a TV image on users' eyes can be reduced, and hence human eyes can be protected. For the same reason, when the TV set is switched off, the TV OSD patterns change from pattern 130 to pattern 120, then from pattern 120 to pattern 110, and this effect makes a smooth closing over the TV content image, which looks just like shutter's closing. In this way, light stimulation of sudden disappearance of the TV image on users' eyes can be reduced, and it also achieves a purpose of protection of eye.

FIG. 1D˜1E is a diagram showing a part of characters and word module information according to an embodiment of the invention. Pattern 110, pattern 120 and pattern 130 are formed of character 140, character 144 and character 148 in FIG. 1D respectively. In order to make the change of the TV OSD patterns look smoother, more characters such as character 142, character 146 in FIG. 1D can be added to increase sorts of the change of the TV OSD patterns. Theoretically, the sort of the change of character depends on its lattice format of word module, such as 16*18 or 10*12. For 16*18 lattice, there are 16 kinds of change mode if the characters change line by line horizontally. FIG. 1E is a diagram showing three lattice formats of word module corresponding to respective characters. The frame-lines in FIG. 1D and FIG. 1E do not exist virtually, they just serve as foils to transparent areas of characters.

For the word module information of character, Chinese standard GB 2312 << [symbol] (Character Set of Chinese Character Encoding for Information Technology and Information Exchange)>> (1981) or other industrial, national or international standards can be referred to. Of course, new characters can be created according to above-mentioned standards.

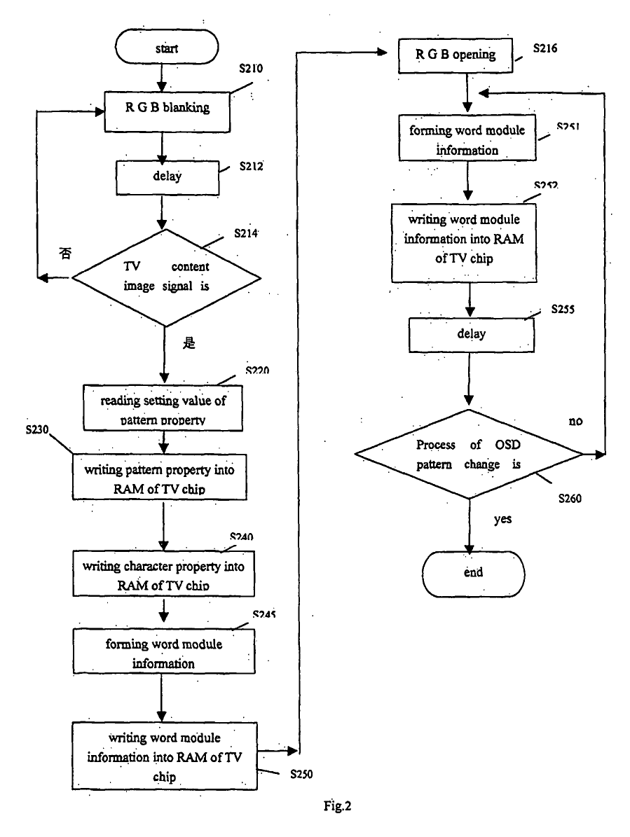

FIG. 2 is a flow chart showing a running process of TV OSD software when the TV set is switched on according to an embodiment of the invention. First, when the TV set is switched on, the TV set blanks RGB (step 210), which is a part of a standard starting procedure. Then it enters a delay state (step 212). Next, it is detected whether the TV content image signal is stable (step 214), if not, it returns to the delay state (step 212) and stay there until the detected TV content image signal being in the stable state.

While waiting for the TV content image signal to be stable, a section of starting OSD pattern in the TV OSD software begins to run. Firstly, read setting values of pattern properties stored in NVM (Non-Volatile Memory) on a TV mainboard (step 220), the setting values of the pattern properties including kinds of pattern, colors of pattern and changing properties of pattern, the kinds of pattern including shutter, curtain up/down, box-in, etc.; the colors of pattern including red, green, blue, black, mixed color, transparency, translucence, etc.; the changing properties of pattern including changing speed, changing directions (vertical horizontal, diagonal, etc.), etc.

Secondly, write the pattern properties into RAM of TV chip according to the read in formation (Step 230), the written pattern properties being obtained by further categorizing the pattern properties of step S220, including shape s of pattern, the colors of pattern, sizes of patter, positions of pattern on screen, etc.; the shapes of pattern including shutter, curtain, rectangle, brand-mark, etc.; the sizes of pattern including full screen, half screen, quarter of screen, etc.; the positions of pattern on screen including in the center, in the upper left corner, in the lower right corner, etc. If all of the pattern properties required in this step has been programmed into the TV OSD software, step S220 is not necessary.

Next, write the character properties into RAM of TV chip (step 240), these character properties being obtained by further categorizing the pattern properties of step S230, including the colors of character, the positions of character on screen, a lattice format of character, a location in RAM of the word module information of character when written in TV chip, etc.; the colors of character including red, green, blue, black, mixed color, transparency, translucence, etc.; the lattice formats of character including 16*18,10*12, etc.

Then, form the word module information of character instantly (step 245), the detailed description of this step is as follows, and then write the formed word module information into RAM of TV chip (step 250).

When the detected TV content image signal has been in a stable state, open the RGB scanning signal (step 216) , form a group of new word module information instantly (step 251) write the formed word module information into RAM of TV chip (step 252), and then enter the delay state (step 255). The above-mentioned changing speed of pattern can be realized by adjusting the delay time in step S255.

Finally, detect whether the OSD pattern changing process is completed (step 260). If not, return back to form a new group of word module information (step 251) and repeat above steps until the OSD pattern changing process is completed, meaning the section of starting OSD pattern in the TV OSD software has been finished.

For the TV chip with function of setting screen color, the screen color can be set up while opening RGB (step 216). In this case, step 220, step 230, step 240, step 245 and step 250 can be executed after RGB has been opened (step 216). According to user's OSD pattern setting, step 220, step 230 and step 240 can be added to the running circulation composed of step 251, step 252, step 255 and step 260.

The forming step 245/step 251 can form the characters in the embodiment as shown in FIG. 1 in a predetermined sequence, these characters being a series of characters 140, 142, 144, 146 and 148 which become transparent gradually from upper and lower edges to a center area in a predetermined sequence, and these characters forming the pattern on TV screen change in a predetermined sequence (character 140→character 142→character 144→character 146→character 148), the changing effect looks like a shutter. Character 140, character 142, character 144, character 146 and character 148 can be created instantly by using a circulation algorithm in the TV OSD software. In this algorithm all lattice points in an entire line will be set to 0 gradually from the upper and lower edges to the center area. Of course, it is possible to form different shapes of character via different algorithms according to respective pattern properties in these steps. The word module information of this group of characters can also be read from the word bank stored in ROM of TV chip.

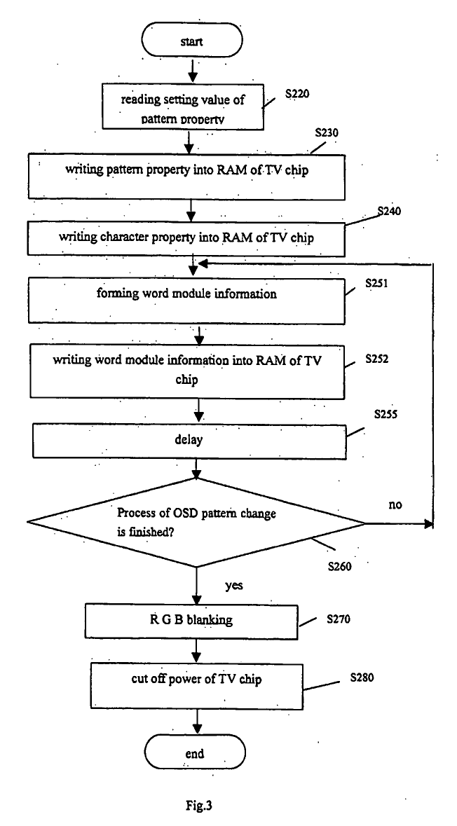

FIG. 3 is a flow chart showing a running process of the TV OSD software when the TV set is switched off. When a shutdown signal is received, a shutdown OSD pattern section of the TV OSD software begins to run. The running process of this section is similar to the starting OSD pattern section, so description of the same steps will be omitted for concision. Because an user may choose a pattern for starting different from that for shutdown, this difference will cause corresponding changes in pattern property, character property, etc. In addition, even if the user chooses the same pattern for starting as that for shutdown, the display of the TV content image signal for shutdown is contrary to that for starting so that characters 140, 142, 144, 146 and 148 which form the pattern on TV screen change in the sequence of character 148→character 146→character 144→character 142→character 140, as different from the change sequence for starting in which the OSD pattern disappears gradually while the TV content image signal reveals gradually when the TV set is switched on. When the process of the shutdown OSD pattern is completed, TV set blanks RGB (step 270), and then the power for TV chip is cut off (step 280).

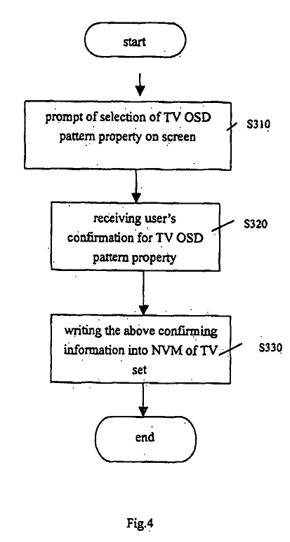

FIG. 4 is a flow chart showing user's setting up TV OSD pattern properties for starting and shutdown of the TV set OSD. Once the TV is switched on, the user can set up desired starting/shutdown patterns using remote controller or local buttons on the TV set according to menu instructions on a TV screen.

First, TV OSD software shows a prompt of the OSD pattern properties on the screen, from which the user may choose the one he wants (step 310). Being similar to the above, the pattern properties include the using opportunities of pattern, the kinds of pattern, the colors of pattern, the sizes of pattern, the positions on screen of pattern and the changing properties of pattern, the using opportunities of pattern including the starting pattern, shutdown pattern, etc.; the kinds of pattern including shutter, curtain up/down, box-in/out, etc.; the sizes of pattern including the original size on which a pattern change just begins and the final size on which the change has finished; the colors of pattern including red, green, blue, black, mixed color, transparency, translucence, etc; the change properties of pattern including the changing speed, the changing direction (horizontal, vertical, diagonal, etc.), etc.

When a user's confirmation of choice of OSD pattern property is received (step 320), write the user's confirming information into NVM (Non-Volatile Memory) on a TV mainboard (step 330). A main function of NVM is that data information can be written-in repeatedly, the information will not be lost when a power is off, and the information can be read-out when the power is on again. Devices with the similar function can also be used.

The present invention has been described with reference to the specific embodiments in detail, it is apparent for skilled persons in the present art to make some alternatives, modifications and changes according to the above depiction. For example, the pattern property, the character property and the word module information can be written into designated RAM being not on TV chip, as long as this RAM can do data exchange with a micro-processor on TV chip. Therefore, all of these alternatives, modifications and changes should be included in the present invention when they fall in the spirit and the scope of the appendant claims.

What is claimed is:

1. A method for displaying a character on a TV screen, comprising steps:
real time generating character matrix information;
displaying the character matrix information on the TV screen in a corresponding form of the character.

2. The method according to claim 1, wherein the generating step comprises generating the matrix information by using a predetermined algorithm.

3. The method according to claim 1, wherein the generating step comprises real time generating the matrix information by using a TV OSD software.

4. An apparatus for displaying character on a TV screen, comprising:
means for real time generating character matrix information;
means for displaying the generated character matrix information on the TV screen in a corresponding form of the character.

5. A method for displaying a TV OSD pattern on a TV screen, comprising steps:
writing-in a predetermined pattern characteristic into a specific RAM of the TV;
writing-in a predetermined character characteristic into a specific RAM of the TV;
real time generating character matrix information in a predetermined pattern change sequence according to said pattern and character characteristics; and
writing-in the generated character matrix information into a specific RAM of the TV, to make the TV OSD pattern consisting of the corresponding characters changing gradually on the TV screen.

6. The method according to claim 5, further comprising step:
reading the predetermined pattern and character characteristics from a specific device of the TV.

7. The method according to claim 5, wherein said pattern characteristic comprises changing characteristic of the pattern.

8. The method according to claim 5, wherein said pattern characteristic comprises the shape of the pattern, the size of the pattern and the position on the screen of the pattern.

9. The method according to claim 5, wherein said character characteristic comprises the color of the character and the position on the TV screen of the character.

10. The method according to claim 5, wherein the step of writing-in the generated character matrix information comprises a delaying step to control the change rate of the pattern.

11. The method according to claim 5, wherein the characters of the step of writing-in the generated character matrix information are a series of characters which become transparent gradually in a predetermined sequence from an upper edge and a lower edge to a central area, and said characters look like opening and closing of a blind when the pattern consisting of said characters on the TV screen changes in a predetermined sequence.

12. The method according to claim 11, wherein the character matrix information of said series of characters which become transparent gradually toward a central area in a predetermined sequence is real time generated by a loop algorithm of a TV OSD software, and said loop algorithm gradually sets the lattice of a whole line into zero gradually from an upper and a lower edges to the central area of the characters.

13. An apparatus for displaying a TV OSD pattern on a TV screen, comprising:
means for writing-in a predetermined pattern characteristic into a specific RAM of the TV;
means for writing-in a predetermined character characteristic into a specific RAM of the TV;
means for real time generating character matrix information in a predetermined pattern change sequence according to said pattern and character characteristics; and
means for writing-in the generated character matrix information into a specific RAM of the TV, to make the TV OSD pattern consisting of the corresponding characters changing gradually on the TV screen.

14. The apparatus according to claim 13; further comprising means for reading the predetermined pattern and character characteristics from a specific device of the TV.

15. The apparatus according to claim 13, wherein said characters are a series of characters which become transparent gradually in a predetermined sequence from an upper edge and a lower edge to the central area, and said characters look like opening and closing of a blind when the pattern consisting of said characters on the TV screen changes in a predetermined sequence.

16. A TV, comprising:
a screen; and
a screen character displaying apparatus, the screen character displaying apparatus further comprising:
means for real time generating character matrix information; and
means for displaying the generated character matrix in a corresponding character form on the TV screen.

17. A TV, comprising:
a screen;
a screen pattern displaying device, the screen pattern displaying device further comprising:
means for writing-in a predetermined pattern characteristic into a specific RAM of the TV;
means for writing-in a predetermined character characteristic into a specific RAM of the TV;
means for real time generating character matrix information in a predetermined pattern change sequence according to said pattern and character characteristics;
means for writing-in the generated character matrix into a specific RAM of the TV, to make the TV OSD pattern consisting of the corresponding characters changing gradually.

18. A method for displaying a TV OSD pattern on a TV screen, comprising steps:
writing-in a predetermined pattern characteristic into a specific RAM of the TV;
writing-in a predetermined character characteristic into a specific RAM of the TV;
reading-in character matrix information in a predetermined pattern change sequence from a character storage stored in a specific position of the TV, according to said pattern and character characteristics;
writing-in the reading-in character matrix information into a specific RAM of the TV to make the TV OSD pattern consisting of the corresponding characters looks like opening and closing of a blind when it changes gradually on the TV screen.

19. A method for setting a TV OSD pattern on a TV screen when turning on or off the TV, comprising steps:
prompting optional items of the TV OSD pattern characteristic on the TV screen;
accepting the selection and confirmation of an user for the TV OSD pattern characteristic; and
writing-in the received confirmation information into a non-volatile storage of the TV.

20. The method according to claim 19, wherein said pattern characteristic comprises the using opportunity of the pattern; the type of the pattern; the color of the pattern; the shape of the pattern; the size of the pattern; the position on the screen of the pattern and the change characteristic of the pattern.
